(19) United States
(12) Patent Application Publication
(10) Pub. No.: US 2024/0029926 A1
(43) Pub. Date: Jan. 25, 2024

(54) FUSE ASSEMBLY OF A SURGE ARRESTER INDICATOR

(71) Applicant: Siemens Energy Global GmbH & Co. KG, München (DE)

(72) Inventors: Bernd Kruska, Berlin (DE); Ralf Rössler, Berlin (DE)

(21) Appl. No.: 18/257,638

(22) PCT Filed: Nov. 30, 2021
(86) PCT No.: PCT/EP2021/083483

§ 371 Date: Jun. 15, 2023

(30) Foreign Application Priority Data
Dec. 15, 2020 (DE) 10 2020 215 914.9

(51) Int. Cl. H01C 7/12; H01C 1/02

(52) U.S. Cl. CPC H01C 7/126; H01C 1/02

(57) ABSTRACT

A fuse assembly is formed with a receiving chamber. The receiving chamber is used for receiving a surge arrester indicator. The receiving chamber is a fireproof chamber and the surge arrester indicator is arranged in the fireproof receiving chamber.

The invention relates to a protective assembly of a surge arrester indicator.

A protective assembly of this type is known, for example, from the U.S. Pat. No. 7,656,639 B2. Described therein is a surge arrester assembly which has a disconnecting device. The disconnecting device is secured by means of a holder. In the event of the disconnecting device bursting, parts of the disconnecting device which are connected to the holder can be retained. A disadvantage of this configuration is that a choice always needs to be made as to which parts are to be secured by means of the holder. Depending on the expected bursting behavior of the disconnecting device, different more or less complex holders thus need to be provided to ensure sufficient fixing of expected burst parts.

The object of the invention is therefore to provide a protective assembly of a surge arrester indicator which has an improved protective effect.

The object is achieved in the case of a protective assembly of the type mentioned at the beginning by the protective assembly having a fireproof receptacle for the surge arrester indicator.

A surge arrester indicator serves to display a state of a surge arrester. A surge arrester is in turn provided to relieve surges occurring in electrical energy transmission grids. For this purpose, a surge arrester is integrated into a discharge current path. A discharge current path usually extends from a current-conducting phase conductor to a ground potential. The phase conductor is provided to conduct an electrical current, driven by a voltage applied thereto.

Electrical voltages are here preferably electrical voltages lying in the high-voltage range. High voltage is understood as voltages of greater than 1000 V, more than several 10,000 V, several 100,000 V up to millions of volts. In order to counteract continuous through-connection of a discharge current path connecting the phase conductor to ground potential, a surge arrester is inserted into the discharge current path. The surge arrester has voltage-dependent impedance behavior. Below a threshold voltage, the surge arrester has high-impedance behavior. Above a threshold voltage, the surge arrester has low-impedance behavior. The possibility is consequently provided of allowing a discharge current to flow via the ground current path when unexpected surges occur (voltages above a threshold voltage), as a result of which the surge is reduced. When the surge is relieved to a point below the threshold voltage of the surge arrester, the surge arrester reassumes high-impedance behavior and the discharge current path is interrupted. Because the surge arrester is a real component, a so-called leakage current also occurs in the event of high-impedance behavior. The leakage current is a current which is highly limited by the high impedance of the surge arrester and also flows out via the discharge current path in the high-impedance state of the surge arrester.

In the event of faults at the surge arrester or overloads of the surge arrester, failure of the latter can occur. Failure can here manifest itself in such a way that a short-circuit occurs at the surge arrester and its functioning is thus no longer guaranteed. Such failures are often not immediately evident at the surge arrester. Accordingly, surge arrester indicators are provided which show the state of the surge arrester. Surge arrester indicators can be provided, for example, in order to disconnect the discharge current path irreversibly and by virtue of the disconnection to indicate the surge arrester state (surge arrester disconnecting device).

A surge arrester indicator can, however, also be configured to draw attention only to a display or signaling of a state of the surge arrester. This can also happen by the discharge current path not being interrupted and only a displaying of, for example, the occurrence of a discharge procedure or an overload of the surge arrester taking place (surge arrester signaling device). In order to trigger a response from a surge arrester indicator, the surge arrester indicator can, for example, evaluate the discharge current flowing in the discharge current path. Depending on the strength of the discharge current, a response is made by the surge arrester indicator. In the case of very high discharge currents which would cause a thermal overload of the surge arrester, the discharge current path can be disconnected by the surge arrester indicator. In this case, the use of a surge arrester disconnecting device needs to be provided which disconnects the discharge current path. In the case of a response of the surge arrester under normal conditions, it is often desirable to detect that a response of the surge arrester is present. By virtue of such a display, it is possible to identify and check the surge arrester in a simplified fashion. In this case, a surge arrester indicator in the form of a surge arrester signaling device needs to be provided. Several alternative embodiments of a surge arrester indicator may also be used on the same surge arrester. Furthermore, a surge arrester indicator can also fulfill several functions: for example, it can serve as a surge arrester disconnecting device, on the one hand, and also as a surge arrester signaling device, on the other hand.

The surge arrester indicators can have different types of structure for disconnecting a discharge current path and displaying a change at the surge arrester. For example, a surge arrester indicator can have mechanically tensioned assemblies or chemical components. Mechanically tensioned components can be, for example, drive devices which are powered by spring force. Chemical components can be contained, for example, in batteries, semiconductor elements, expansion drives, explosive materials, etc.

The equipping of the protective assembly with a fireproof receptacle makes it possible to arrange the surge arrester indicator to a large extent and preferably almost completely inside the receptacle. By virtue of the fireproof configuration of the receptacle, it is made difficult for thermal energy from outside to act on the surge arrester indicator. Similarly, it is also made difficult for thermal energy from inside the receptacle to pass into the surroundings when a thermal event occurs inside the receptacle. Those parts of the surge arrester indicator which themselves represent a thermal risk for the environment or which react sensitively to thermal influences from the environment should preferably be arranged inside the receptacle. In particular, abovedescribed mechanically tensioned assemblies and chemical components should preferably be arranged essentially completely inside the receptacle. It can be provided here that parts of the surge arrester indicator are arranged both inside and outside the receptacle. In this case too, it needs to be ensured that the regions which may traverse a wall of the receptacle do not significantly reduce the fire resistance of the receptacle. Assemblies of the surge arrester indicator which can be arranged outside the receptacle and can traverse a wall of the receptacle are, for example, the housing, contact elements, bolts, etc. The protective effect of the receptacle from thermal influences is thus preserved. The receptacle should thus have walls which cannot melt or soften or burn in an open fire. A fireproof receptacle is present in particular in particular when it meets the following conditions: the walls of the receptacle must not burn or melt or soften when they are exposed uninterruptedly to a flame which can heat a steel cube of 125 cm³, with a side length of 5 cm and a mass of circa 1 kg, with a heating-up speed of 80 K/min±5 K/min from 20° C. to 200° C. This should be the case at least until a surge arrester indicator situated at least partially in the receptacle has responded (for example, the triggering of mechanical assemblies or chemical components of a drive device). The receptacle should typically maintain the fire resistance for several minutes (for example, 5 minutes or multiples of 10 minutes such as 10 minutes, 20 minutes, 40 minutes, and 60 minutes).

A further advantageous configuration can provide that the receptacle is shatterproof.

In particular when explosive materials are used (for example, in expansion drives) and they may be triggered unintentionally, shattering can occur inside and outside the receptacle. It is made more difficult for fragments, etc to penetrate inside the receptacle because of the shatter resistance of the receptacle. Similarly, it is also made difficult for particles and fragments to escape from the receptacle when an event occurs inside the receptacle. The shatter resistance should here be configured such that no fracturing or shattering of the walls delimiting the receptacle occurs and that the surge arrester indicator and parts (splinters) detached therefrom do not travel more than 1 m.

The receptacle here needs to be shatterproof only in such a way that it is made difficult for a significant escape of fragments or penetration of fragments from or into the receptacle to occur. In the case of such a shattering event occurring, this can cause irreversible destruction of the receptacle. Only a sufficient slowing down or stopping of the corresponding fragments is necessary. Shatter resistance is in particular of interest when the surge arrester indicator has an explosive material for the purpose of driving it. Safe containment of the surge arrester indicator is thus ensured in particular for transporting the surge arrester indicator.

It can advantageously further be provided that the receptacle is soundproof.

In addition to thermal and/or mechanical stresses, the receptacle can also be exposed to an elevated sound level. By virtue of the soundproofing of the receptacle, for example, even when high sound pressures occur outside the receptacle, the influence on assemblies of the surge arrester indicator which are situated inside the receptacle is counteracted. Furthermore, by virtue of a soundproof configuration of the receptacle, it can be made difficult for sound to escape from inside the receptacle. In particular, in the case of triggering of the surge arrester indicator and the sound exposure this entails, the environment can be protected. The sound protection should here be configured in such a way that a bang that is audible (to a human) within one meter does not exceed a peak value of over 135 dB (C) in the event of a sound event occurring in the receptacle.

Irrespective of the configuration of the receptacle or the manner of the arrangement of the surge arrester indicator, the thermal and/or acoustic and/or mechanical resistance is ensured essentially by the design of the walls of the receptacle. Recesses, sockets, passages, joints, etc which may need to be provided on the receptacle are designed in such a way that the desired protective effect of the receptacle is ensured.

A further advantageous configuration can provide that the receptacle has a first access opening and a first closure element for the first access opening, wherein the first closure element secures the first access opening in a force-fitting fashion.

It is possible to obtain access to the receptacle via a first access opening. The first access opening can here be closed by means of a first closure element. Correspondingly, the closure element and the access opening can be moved apart from each other such that access to the receptacle is enabled. A surge arrester indicator can, for example, be introduced into the receptacle via the first access opening. Force-fitting securing of the first closure element on the first access opening makes it possible to provide secure installation of the first closure element. Force-fitting securing can be effected, for example, by means of elastic elements such as springs or alternatively by means of threaded bolts. The possibility is consequently afforded of repeatedly removing the first closure element from the first access opening and securing it there. For example, recesses, which are traversed by threaded bolts which position and secure the first closure element in force-fitting fashion, can be provided in the first closure element. A threaded bolt can here protrude through a corresponding recess in a closure element in such a way that it furthermore influences the fire resistance and/or shatter resistance and/or soundproofing of the receptacle to a negligible extent. This can be effected, for example, by corresponding fits or sealing means.

The first receptacle can advantageously be configured in the manner of a cylinder, wherein a circular cylindrical or elliptical end face should preferably be provided. In the case of a cylindrical configuration of the first receptacle, an end side is preferably to be chosen for the position of the first access opening. In this case, the application of a force can take place in the direction of the cylinder axis for the force-fitting connection of the first closure element.

It can furthermore advantageously be provided that the receptacle is essentially delimited by hollow cylindrical walls.

A hollow cylindrical wall has the advantage that a receptacle can be delimited in a mechanically stable fashion. A circular or elliptical hollow cylindrical shape is advantageously provided for the receptacle. A hollow cylindrical configuration of a receptacle furthermore has the advantage that it has a suitable basic structure in terms of the mechanical strength, for example with respect to fragments and splinters and in terms of fire resistance. Introducing a surge arrester indicator into the receptacle and withdrawing it can here preferably take place in the direction of the axis of the hollow cylinder. The arrangement of an access opening on an end side of the receptacle is advantageous here.

A further advantageous configuration can provide that a closure element is inserted into a loose fit or press fit or sliding fit.

The closure element must close the associated access opening in such a way that the requirements in terms of fire resistance and/or shatter resistance and/or soundproofing are met. A corresponding stability at the transition between the wall and the closure element can be produced by a suitable choice of the fit between the closure element and the access opening or the wall of the receptacle delimiting the access opening. The use of a loose fit is, for example, advantageous when a mechanically overdetermined construction would result and the possibility of compensation is created in the loose fit. Over- and undersizing in the press fit can be compensated by the use of a press fit. A sliding fit is advantageous in order to repeatedly carry out opening and closing of the receptacle. Correspondingly precisely dimensioned components need to be used for the sliding fit such that the joining gap has the required quality even after the receptacle has been opened and closed multiple times.

It can further advantageously be provided that a closure element has a metal seal seat.

A closure element serves to close an access opening. A joining gap is formed between the closure element and a wall which delimits the access opening. Depending on the requirements for the resistance of the receptacle, the joining gap is equipped with a corresponding precision of fit. The use of a metal seal seat allows a high degree of resistance to be ensured in terms of thermal influences. Preferably, metal surfaces which come to bear directly or indirectly on each other are formed in the region of the joining gap between the wall and the closure element. In the case of indirect bearing, a metal sealing element such as, for example, a copper sealing ring can be inserted into the joining gap.

A further advantageous configuration can provide that the surge arrester indicator is fixed on a closure element.

The surge arrester indicator which is to be accommodated in a receptacle is advantageously arranged at a fixed angle relative to a wall delimiting the receptacle. A closure element can advantageously serve to fix the surge arrester indicator at a fixed angle. This has the advantage that a connection can be produced between the closure element and the surge arrester indicator outside the receptacle before an access opening is closed by a closure element. Thus, introduction of the surge arrester indicator into the receptacle and almost simultaneous closure of the latter in one step is enabled. A recess can be provided in the closure element in order to receive the surge arrester indicator. A bolt, by means of which screwing or force-fitting clamping of the surge arrester indicator to the closure element is enabled, can, for example, protrude into the recess. A plurality of bolts may optionally be used for the purpose of better fixing or securing in position. It can, however, also be provided that, for example, shoulders or moldings of the surge arrester indicator protrude, for example, into a recess of the closure element. For clamping or fastening purposes, threaded bolts or threaded bores can be used which are situated, for example, on the surge arrester indicator in order to electrically contact or retain the latter on a surge arrester.

It can furthermore advantageously be provided that a closure element is secured by means of a bolt at least partially traversing the receptacle.

A bolt which serves to secure a closure element can preferably protrude at least partially into the receptacle and traverse it at least partially. Such a bolt can preferably traverse the receptacle in such a way that it traverses two opposite sections of a wall of the receptacle such that a force fit via bolt heads or threaded heads outside the receptacle is ensured. It is thus possible, for example, to allow bolts provided for fixing a closure element in each case to be supported on the walls. This is a mechanically simple and stable design. Furthermore, such a bolt can be used to effect fastening of the surge arrester. For example, a bolt can protrude through a recess and, inside the receptacle, into a matching counterthread of the surge arrester indicator. Alternatively, it can also be provided that a recess inside the surge arrester indicator is traversed by a bolt, wherein the latter is supported on walls of the receptacle.

A further advantageous configuration can provide that the surge arrester indicator is connected to the bolt and in particular is traversed by the bolt.

Connection of the surge arrester to a bolt or traversing of the surge arrester indicator by a bolt makes it possible, on the one hand, to effect closure of an access opening of the receptacle by means of a closure element and to secure it in force-fitting fashion. On the other hand, this construction can also be used to secure the surge arrester indicator relative to a wall of the receptacle. The bolt can, for example, draw a surge arrester indicator against a wall (inner side of the receptacle) and clamp it in force-fitting fashion. A bolt can also completely traverse the surge arrester indicator and connect it to opposite sections of the wall of the receptacle and clamp it therebetween. The mechanical stability of the walls of the receptacle can be additionally reinforced by connection of the surge arrester indicator to bolts and the receptacle. For example, reinforcement can be obtained by means of the bolts by these opposite wall sections of the receptacle being connected to each other. Alternatively or additionally, it can also be provided that, by virtue of the surge arrester indicator bearing against a wall of the receptacle, this wall is itself reinforced and stabilized.

It can furthermore advantageously be provided that the receptacle has a second access opening and a second closure element, wherein the first and the second closure element are clamped to each other in force-fitting fashion.

The use of a second access opening and of a second closure element in addition to the first access opening and the first closure element enables simplified access to the inside of the receptacle. In particular when the access openings are oriented so that they are aligned with each other, the possibility of reaching through the two access openings with tools or the like can be provided. Accordingly, the mounting of a surge arrester indicator and its introduction into the receptacle is simplified. The possibility is also afforded of clamping the two closure elements to each other in a force-fitting fashion, for example via bolts. The two closure elements can be supported at body edges of the respective access opening which are oriented in opposite directions such that the closure elements can be bolted directly to each other. The bolts provided for the bolting together here completely traverse the receptacle. The bolts can here also be used to position, for example, a surge arrester indicator inside the receptacle. It has proved advantageous to delimit a receptacle with a hollow cylindrical wall, wherein in each case one of the access openings is arranged on the end side. The respective access opening can then be closed with a respective closure element. Clamping can be effected essentially in alignment with the cylinder axis by at least one bolt.

A further advantageous configuration can provide that a closure element has a receiving groove into which a body edge delimiting an access opening can be inserted.

The use of a receiving groove allows a body edge delimiting the access opening to protrude into this receiving groove. The groove can here have different types of profiles. In particular the use of a rectangular groove profile which can be placed on a body edge delimiting the access opening with a suitable fit (loose fit, press fit, sliding fit) has proved to be suitable. The use of a groove furthermore has the advantage that a deviation in a joining gap is provided, as a result of which the necessary quality for forming the joining gap can be achieved in a simplified form.

A further advantageous configuration can provide that at least one wall delimiting the receptacle is designed with multiple layers.

A wall designed to delimit the receptacle must be configured as fireproof, shatterproof, and soundproof according to the necessary classification. A multilayer design of a wall enables the wall to be designed in an optimized fashion in terms of its resistance. A first layer can advantageously serve to form a mechanical stability of the wall. For example, the first layer can be a metal layer. A second layer which adjoins the first layer can, for example, have properties which are improved in terms of sound protection and bear against the first layer. A loose connection can exist between the layers. For example, the second layer can be in contact with a surge arrester indicator arranged in the receptacle and effect filling of the receptacle.

It can advantageously further be provided that at least one wall delimiting the receptacle has a fluid-tight first layer and a fibrous second layer, in particular one containing ceramic fibers.

A fibrous configuration of the second layer enables an acoustic damping effect to be produced in the immediate vicinity of the surge arrester indicator. The use of ceramic fibers furthermore has the advantage that they are configured favorably with sufficient flexibility in terms of thermal resistance. Furthermore, the flexibility of the second layer, for example in the case of a loose fit being used, enables the fit or the joining gap of a loose fit to be closed in a sound-insulating fashion.

It can furthermore advantageously be provided that the receptacle is transportable.

A transportable configuration of the receptacle enables the protective assembly to be used as a transporting container for the surge arrester indicator. As such, the surge arrester indicator is protected from external influences during transport. Furthermore, the surroundings are protected from the surge arrester indicator by the protective assembly enclosing it.

An exemplary embodiment of the invention is shown schematically below in drawings and described in detail below.

In the drawings:

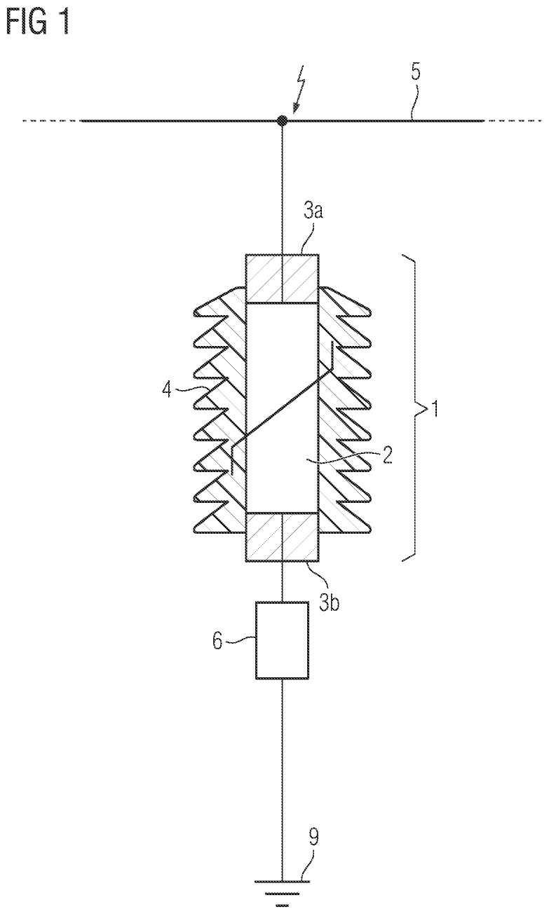

FIG. 1 shows a surge arrester together with a surge arrester indicator,

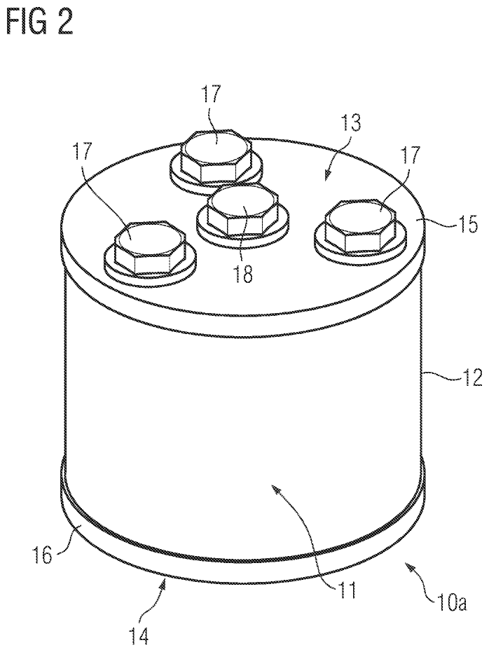

FIG. 2 shows a perspective view of a first alternative embodiment of a protective assembly,

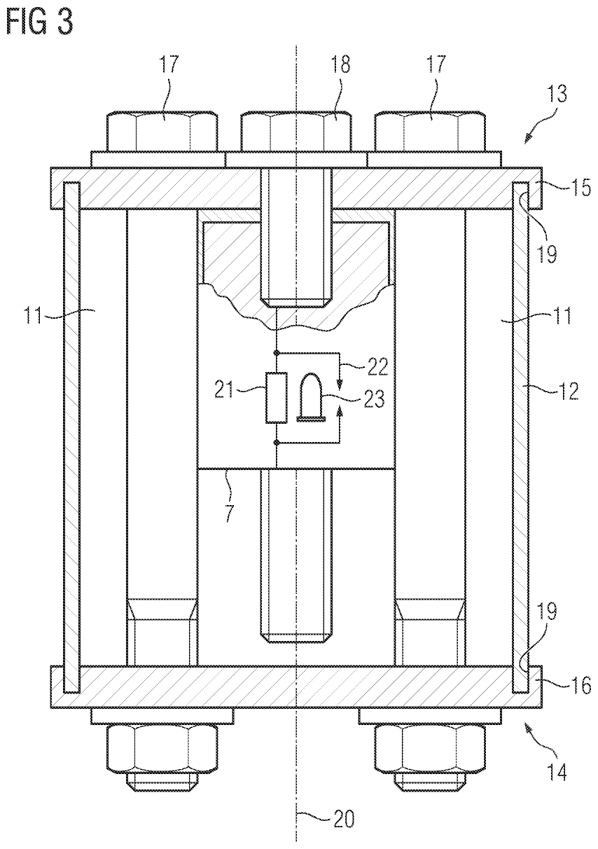

FIG. 3 shows a cross-section through the first alternative embodiment of the protective assembly,

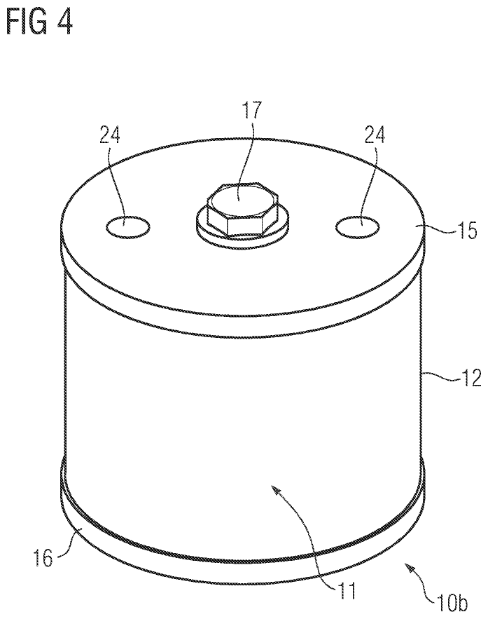

FIG. 4 shows a perspective view of a second alternative embodiment of a protective assembly, and

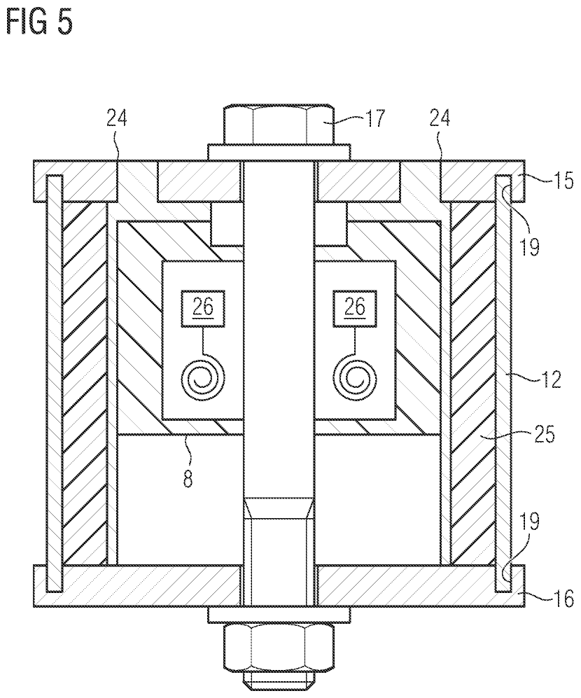

FIG. 5 shows a cross-section through the second alternative embodiment of the protective assembly.

FIG. 1 shows a surge arrester 1. The surge arrester 1 has a varistor 2. The varistor 2 is closed at its ends by a first end fitting 3a and a second end fitting 3b. Electrical contacting of the surge arrester 1 is possible via the end fittings 3a, 3b. In order to configure the surge arrester 1 so that it is weatherproof, it is enclosed by an electrically insulating housing 4, wherein the end fittings 3a, 3b arranged at the ends can also be contacted electrically.

The first end fitting 3a is contacted by a phase conductor 5 in an electrically conductive fashion. The phase conductor 5 is, for example, a phase conductor 5 of a high-voltage transmission line which needs to be protected from surges which are, for example, triggered by lightning strikes. The second end fitting 3b is connected to a surge arrester indicator 6 in an electrically conductive fashion. The contacting provided for electrically conductive connection to the second end fitting 3b serves also to mechanically retain and support the surge arrester indicator 6 on the surge arrester 1. The surge arrester indicator 6 can be configured, for example, as a surge arrester disconnecting device 7 (see FIG. 3) or a surge arrester signaling device 8 (see FIG. 5). The surge arrester indicator 6 is here preferably included in an electrically conductive connection of the second end fitting 3b to a ground potential 9. As such, a discharge current path from the phase conductor 5 to the ground potential 9 is formed. The surge arrester 1 is arranged in the discharge current path for the purpose of controlling the latter. As explained in the general description part, this arrangement serves, when a surge occurs at the phase conductor 5, to relieve the surge by the discharge current path being through-connected by changing the impedance behavior of the varistor 2 and a discharge current flowing from the phase conductor 5 to the ground potential 9. After the surge at the phase conductor 5 has been relieved, the impedance behavior of the varistor 2 changes in such a way that it exhibits high impedance and that only a leakage current can flow via the varistor 2 toward the ground potential 9. Such a leakage current can be tolerated.

In the case of the configuration of the surge arrester indicator 6 in the form of a surge arrester disconnecting device 7, when an overload of the surge arrester 1 or a fault in the surge arrester 1 exists, essentially because of the thermal energy introduced into the surge arrester disconnecting device 7, an (irreversible) disconnection of the discharge current path is provided, wherein this takes place with the surge arrester indicator 6 being destroyed. In the case of the configuration of the surge arrester indicator 6 in the form of a surge arrester signaling device 8, a corresponding signal (optical display) is output only when a value for the current flowing in the discharge current path occurs or is exceeded.

Depending on the configuration and area of application, such a surge arrester indicator 6 can, because of the installed assemblies, represent a risk when it is exposed to certain environmental influences or itself represents a risk. For example, in the case of the configuration of a surge arrester indicator 6 in the form of a surge arrester disconnecting device 7, energy-rich drives, for example spring-operated drives or expansion drives driven by explosive materials, can be used. The same applies for the configuration of the surge arrester indicator 6 in the form of a surge arrester signaling device 8.

In order to avoid risk to the environment from the surge arrester indicator 6 or to the surge arrester indicator 6 from the environment, the use of a protective assembly 10a, 10b is provided.

FIG. 2 shows a perspective view of a first alternative embodiment of a protective assembly 10a. The first alternative embodiment of the protective assembly 10a has a cylindrical receptacle 11 (FIG. 3). The cylindrical receptacle 11 is delimited by a hollow cylindrical shell wall 12. The hollow cylindrical shell wall 12 is provided at its ends with a first access opening 13 and a second access opening 14. The access openings 13, 14 are oriented opposite each other and oriented essentially perpendicularly to a cylinder axis of the hollow cylindrical shell wall 12. The two access openings 13, 14 are then aligned with each other. The two access openings are closed by means of a first closure element 15 and a second closure element 16. The two closure elements 15, 16 are oriented in opposite directions to each other. The two closure elements 15, 16 are, via the bolts 17, pressed against the two access openings 13, 14 with the interposition of the hollow cylindrical shell wall 12 and span the said access openings 13, 14. Respective recesses are introduced into the two closure elements 15, 16 in order to receive the bolts 17. A recess for receiving a central bolt 18 is arranged centrally in the first closure element 15. In order to allow the bolt heads or nuts to bear in sealing fashion against the recesses of the closure elements 15, 16, corresponding washers are provided. A surge arrester disconnecting device 7 is pressed against the closure element 15 via the central bolt 18 (see FIG. 3).

FIG. 3 shows a cross-section through a first alternative embodiment of a protective assembly 10a. It can be seen in the cross-section that both the closure elements 15, 16 and the hollow cylindrical shell wall 12 have a single-layer design and are manufactured from a metal material. The two closure elements 15, 16 are provided with receiving grooves 19. The receiving grooves 19 are provided with an essentially rectangular groove profile, wherein the flanks of the receiving grooves 19 are chamfered to simplify mounting. The groove profile and the circular path of the receiving grooves 19 correspond to the shape of the ends of the hollow cylindrical shell wall 12 which delimits the hollow cylindrical receptacle 11. A sliding fit or a press fit is provided between the respective receiving groove 19 and the shell wall 12 such that a sufficient sealed connection is provided on the receptacle 11 depending on requirements. The surfaces of the shell wall 12 or of the closure elements 12, 16 which touch each other bear directly against each other such that a metal seal seat is formed.

The bolts 17 traverse in each case recesses in the closure elements 15, 16 and thus completely traverse the hollow cylindrical receptacle 11. Bolt heads and bolt nuts are clamped to the outside of the closure elements 15, 16 with the interposition of sealing metal washers. Force-fitting clamping of the closure elements 15, 16 relative to each other on the shell wall 12 is thus created.

The bolts 17 are arranged in the direction of the cylinder axis 20 at the vertices of a triangle. In the space thus delimited in between, the surge arrester disconnecting device 7 is fixed centrally via the central bolt 18. The central bolt 18 here engages in a threaded bore of the surge arrester disconnecting device 7. Clamping or force-fitting bearing of the surge arrester disconnecting device 7 against the first closure element 15 is produced as a result. The threaded bore provided to receive the central bolt 18 serves to electrically contact the surge arrester disconnecting device 7 with a surge arrester 1. At the opposite end, the surge arrester disconnecting device 7 has a threaded bolt. The threaded bolt of the surge arrester disconnecting device 7 protrudes into the receptacle 11 in a free-floating fashion. However, if required, it can also be provided that, with corresponding dimensioning, this threaded bolt traverses the second closure element 16 and is also used for securing the closure elements 15, 16 relative to each other.

The threaded bore and the joining bolts of the surge arrester disconnecting device 7 are held via a housing so that they are electrically insulated from each other. A first current path with an impedance element 21 is arranged inside the housing. A spark gap 22 is arranged parallel to the impedance element 21. Conducting of a leakage current or a discharge current is provided via the impedance element 21. When a threshold value of the discharge current flowing via the impedance element 21 is exceeded (cf design in FIG. 1), a correspondingly high voltage drop occurs via the impedance element 21, as a result of which sparkover occurs at the spark gap 22. A propellant charge 23 can be caused to ignite by the arc (thermal action). The propellant charge 23 can be a blank cartridge. When the propellant charge 23 is triggered, gases are created inside the surge arrester disconnecting device 7, as a result of which destruction of the surge arrester disconnecting device 7 takes place. Such a procedure is desirable when the surge arrester disconnecting device 7 is situated in the assembled state as shown in FIG. 1.

There is a risk of the propellant charge 23 being triggered, for example during transport, by an undesired input of energy. The surge arrester disconnecting device 7 is housed by the first alternative embodiment of the protective assembly 10a. The effects of undesired triggering of the propellant charge 23 are limited to inside the receptacle 11.

FIG. 4 shows a perspective view of a second alternative embodiment of a protective assembly 10b. The second alternative embodiment of the protective assembly 10b is similar to the first alternative embodiment of the protective assembly 10a. Here too a hollow cylindrical shell wall 12 is provided which is closed by a first closure element 15 and a second closure element 16. In contrast to the design of the first alternative embodiment of the protective assembly 10a, only one central opening for receiving a bolt 17 is provided in the first closure element 15 and in the second closure element 16. Furthermore, two further recesses 24 are arranged in the first closure element 15. The recesses 24 serve to lock in rotation a surge arrester indicator 6 arranged in the receptacle 11 of the second alternative embodiment of the protective assembly 10b. The surge arrester indicator 6 according to FIGS. 4 and 5 is in each case a surge arrester signaling device 8. Connection pieces, with a complementary shape, of the surge arrester signaling device 8 protrude into the further recesses 24 (cf FIG. 5). The connection pieces here plug the further recesses 24. It can further be seen in FIG. 5 that a bolt 17 is provided in order to press the two closure elements 15, 16 toward each other. The counterforce required for this is applied by a housing of the surge arrester signaling device 8. The closure elements 15, 16 arranged in each case on the end sides bear against the housing of the surge arrester signaling device 8. In a similar fashion to the configuration of the closure elements 15, 16 according to FIGS. 2 and 3, a receiving groove 19 is also arranged in each case in the closure elements 15, 16 according to FIGS. 4 and 5 on the facing sides. The receiving grooves 19 in turn have an essentially rectangular groove profile, the groove flanks of which are chamfered to improve mounting. The receiving grooves 19 furthermore run in a circle such that the end sides of the hollow cylindrical shell wall 12 can be received. In the present case, the connection between the respective receiving groove 19 and the shell wall 12 is designed in the form of a loose fit.

A fibrous material 25 is arranged on the inside of the hollow cylindrical shell wall 12. The fibrous material 25 has a porous structure and preferably has ceramic fibers. The fibrous material 25 here also has a hollow cylindrical shape and lies on the inside of the hollow cylindrical shell wall 12. The hollow cylindrical shell wall 12 forms a first layer. The fibrous material 25 forms a second layer. A multilayer wall is thus formed. The fibrous material 25 is thus arranged so that it lies on one side against the side of the hollow cylindrical shell wall 12. On the other side, the fibrous material 25 is formed so that it lies against the inside of the housing (which transmits the force between the closure elements 15, 16). The fibrous material 25 furthermore also lies at the end sides against the inner surfaces of the closure elements 15, 16. The fibrous material 25 thus fills a cavity around the surge arrester signaling device 8. In particular a seal of a sliding fit or loose fit between the receiving grooves 19 and the shell wall 12 is produced by the fibrous material 25.

The force-absorbing housing of the surge arrester signaling device 8 encloses a trigger mechanism 26. The trigger mechanism is arranged around a through recess in the surge arrester signaling device 8. The through recess (traversed in the present case by the bolt 17) serves to receive a conductor portion of the discharge current path. The current flow on a flow path traversing the through recess is determined by means of the trigger device 26 (shown in the assembled state as in FIG. 1). In the present case, the trigger device 26 triggers an optical signal at the surge arrester signaling device 8. This is possible, for example, by emitting a color code or by outputting an alarm signal.

1-15. (canceled)

16. A protective assembly of a surge arrester indicator, wherein the protective assembly has a fireproof receptacle for the surge arrester indicator.

17. The protective assembly of the surge arrester indicator according to claim 16, wherein said receptacle is a shatterproof receptacle.

18. The protective assembly of the surge arrester indicator according to claim 16, wherein said receptacle is a soundproof receptacle.

19. The protective assembly of the surge arrester indicator according to claim 16, wherein said receptacle has an access opening and a closure element for closing said access opening, and wherein said closure element is configured to secure said access opening with a force-fit.

20. The protective assembly of the surge arrester indicator according to claim 16, wherein said receptacle is substantially delimited by hollow cylindrical walls.

21. The protective assembly of the surge arrester indicator according to claim 19, wherein said closure element is inserted into a loose fit, or a press fit, or a sliding fit.

22. The protective assembly of the surge arrester indicator according to claim 19, wherein said closure element has a metal seal seat.

23. The protective assembly of the surge arrester indicator according to claim 19, wherein the surge arrester indicator is affixed to said closure element.

24. The protective assembly of the surge arrester indicator according to claim 19, wherein said closure element is secured by way of a bolt that traverses said receptacle at least partially.

25. The protective assembly of the surge arrester indicator according to claim 24, wherein said surge arrester indicator is connected to said bolt.

26. The protective assembly of the surge arrester indicator according to claim 25, wherein said surge arrester indicator is traversed by said bolt.

27. The protective assembly of the surge arrester indicator according to claim 19, wherein said access opening is a first access opening and said closure element is a first closure element, and wherein said receptacle has a second access opening and a second closure element, and wherein said first and second closure elements are clamped to one another in a force-fitting fashion.

28. The protective assembly of a surge arrester indicator according to claim 19, wherein said closure element is formed with a receiving groove for receiving therein a body edge delimiting said access opening.

29. The protective assembly of a surge arrester indicator according to claim 16, wherein at least one wall delimiting said receptacle is formed with multiple layers.

30. The protective assembly of a surge arrester indicator according to claim 16, wherein said receptacle is delimited by at least one wall having a fluid-tight first layer and a fibrous second layer.

31. The protective assembly of a surge arrester indicator according to claim 30, wherein said second layer contains ceramic fibers.

32. The protective assembly of a surge arrester indicator according to claim 16, wherein said receptacle is a transportable receptacle.
